(19) United States
(12) Patent Application Publication
(10) Pub. No.: US 2018/0056308 A1
(43) Pub. Date: Mar. 1, 2018

(54) Adjustable Dual Showerhead

(71) Applicant: Ricardo Borges, Coconut Creek, FL (US)

(72) Inventor: Ricardo Borges, Coconut Creek, FL (US)

(21) Appl. No.: 15/684,525

(22) Filed: Aug. 23, 2017

Related U.S. Application Data
(60) Provisional application No. 62/379,781, filed on Aug. 26, 2016.

(51) Int. Cl. B05B 1/18; B05B 1/16; B05B 15/08; E03C 1/04

(52) U.S. Cl. CPC B05B 1/185; E03C 1/0408; B05B 15/08; B05B 1/16

(57) ABSTRACT

An adjustable dual showering unit contains a first showerhead assembly, a second showerhead assembly, and a showerhead arm. The first showerhead assembly and the second showerhead assembly extend from the showerhead arm allowing multiple individuals to shower together. The distance between the first showerhead assembly and the second showerhead assembly is adjustable. The distance from the showerhead arm to a head portion of both the first showerhead assembly and the second showerhead assembly is also adjustable. Moreover, the orientation of the head portion of both the first showerhead assembly and the second showerhead assembly can be adjusted. Moreover, a fluid flow control valve allows the user to control the first showerhead assembly independent of the second showerhead assembly of vice versa. Thus, a unique showering experience is provided.

The current application claims a priority to the U.S. Provisional Patent application Ser. No. 62/379,781 filed on Aug. 26, 2016.

### FIELD OF THE INVENTION

The present invention relates generally to showerheads. More specifically, the present invention is a dual showerhead with length adjustability, height adjustability, direction adjustability, and the ability to individually control each showerhead.

### BACKGROUND OF THE INVENTION

A variety of showerheads can be seen in the market today. These showerheads vary in design, material, and functionality. Regardless of the changes introduced, most of the showerheads are designed to fulfill the needs of a single user. Thus, the need for a shower unit that can be used simultaneously by multiple users is yet to be addressed.

Another issue with existing showerheads is the limited adjustability. Most existing showerheads can be adjusted at a preferred angle. However, the height in which the water is released from the showerhead and the distance from the wall to the water release point cannot be changed. Height adjustability is beneficial to cater to users of all heights. On the other hand, the ability to adjust the distance from the wall to the showerhead is beneficial to cater users of different body sizes and abilities. As an example, if an elderly person using a shower seat, the ability to extend the showerhead away from the wall is extremely beneficial.

Waste of water is a significant issue with many modern shower systems. As an example, with shower systems with multiple body jets, water is released from all body jets. The inability to control each individual water release point results in additional water consumption.

The objective of the present invention is to address the aforementioned issues. To do so, the present invention introduces an adjustable dual showerhead. Moreover, the present invention has the ability to be height adjustable, length adjustable, angularly adjustable, and have the ability to have individual control of the showerheads. By utilizing the present invention, multiple users can shower together creating an intimate bond between couples. In other instances, the present invention can help parents bathe two children at the same time. The adjustability of the showerhead also helps a user to clean a pet by using a minimal amount of water.

### BRIEF DESCRIPTION OF THE DRAWINGS

FIG. 1 is an illustration of the present invention in use.

FIG. 2 is an illustration of one embodiment of the showerhead arm.

FIG. 3 is an illustration of another embodiment of the showerhead arm.

FIG. 4 is an illustration of the height adjusting mechanism.

FIG. 5 is an illustration of the length adjusting mechanism and the angle adjusting mechanism.

FIG. 6 is an illustration of the neck portion, mount, and the head portion.

### DETAIL DESCRIPTIONS OF THE INVENTION

All illustrations of the drawings are for the purpose of describing selected versions of the present invention and are not intended to limit the scope of the present invention.

The present invention is a shower unit with one or more showerheads in horizontal alignment. The horizontal alignment allows two or more showerheads to release water simultaneously. Thus, multiple users can shower together conveniently. The adjustability available with the present invention allows users of different needs and abilities to utilize the present invention conveniently.

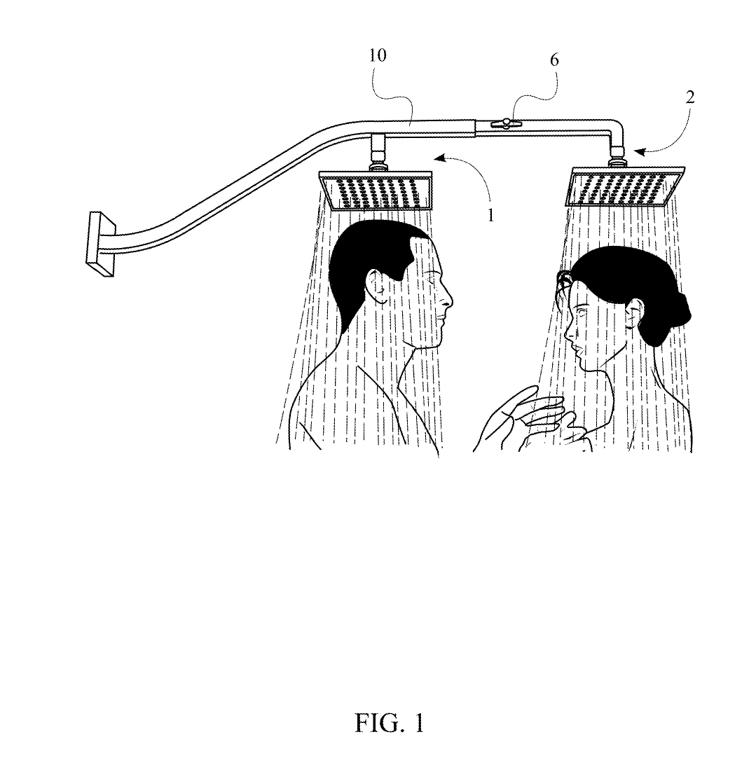

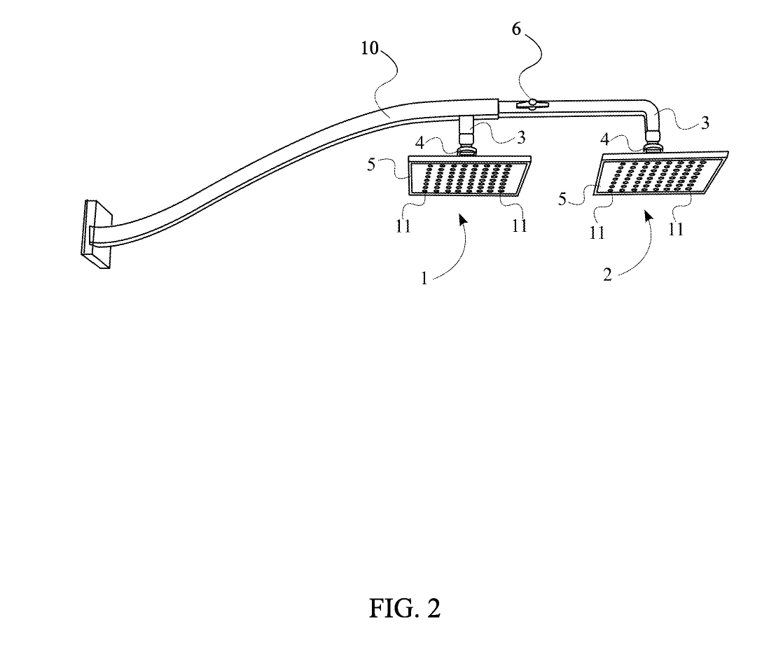

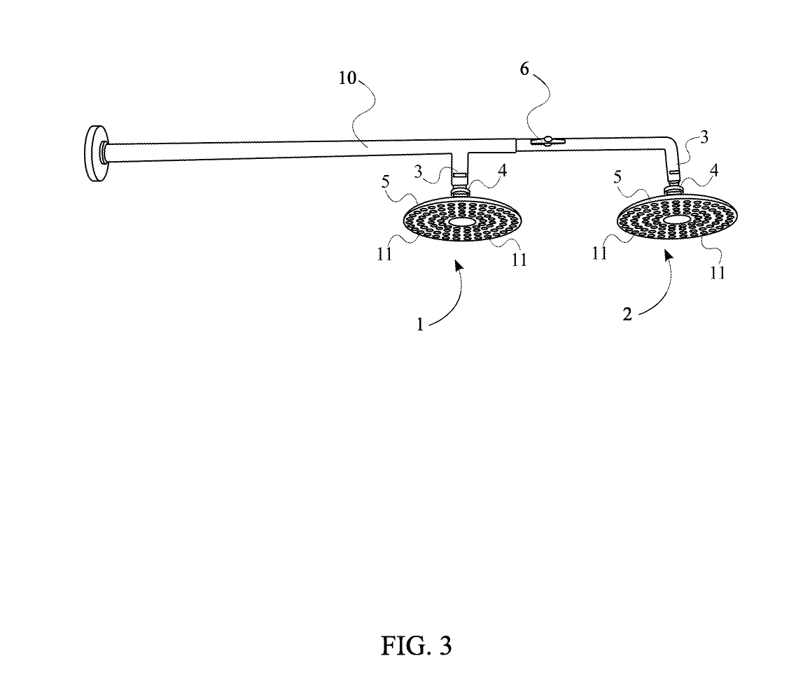

As illustrated in FIGS. 1-5, to allow the present invention to be used by multiple users and to fulfill the needs of the multiple users, the present invention comprises a first showerhead assembly 1, a second showerhead assembly 2, and a showerhead arm 10. The first showerhead assembly 1 and the second showerhead assembly 2 are horizontally aligned along the showerhead arm 10 so that water is released to multiple users. Even though only the first showerhead assembly 1 and the second showerhead assembly 2 are used in the preferred embodiment of the present invention, additional showerhead assemblies can be used in different embodiments of the present invention. The release of water from the first showerhead assembly 1 and the second showerhead assembly 2 can vary from one embodiment to the other as long as the overall functionality of the present invention remains the same. The first showerhead assembly 1 and the second showerhead assembly 2 can be manufactured from material such as, but not limited to, various types of plastic, aluminum or other metals, or any other desired material. As seen in FIG. 2 and FIG. 3, the overall shape of the showerhead arm 10 can also vary from one embodiment to another. As an example, the showerhead arm 10 can be curved in one embodiment allowing tall users to utilize the present invention. In another embodiment, the showerhead arm 10 can be relatively straight.

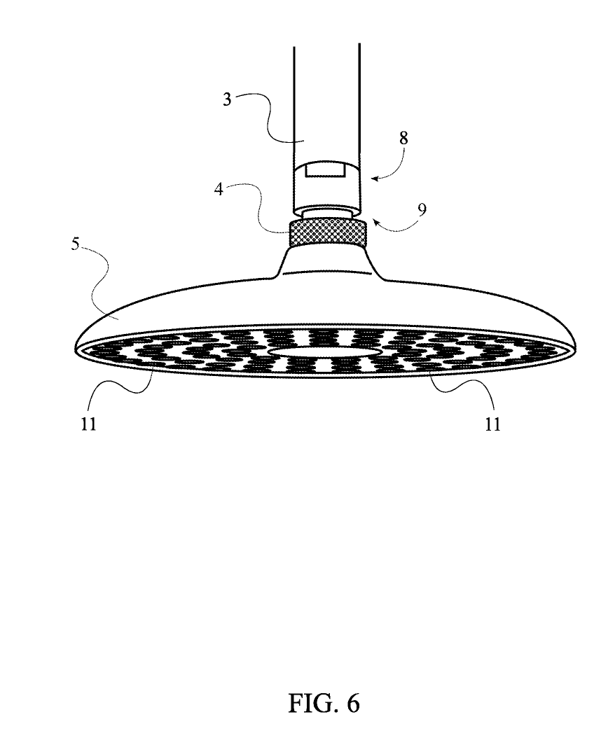

As illustrated in FIG. 6, to connect to the showerhead arm 10 and fulfill other functionalities of the present invention, the first showerhead assembly 1 and the second showerhead assembly 2 each comprise a neck portion 3, a mount 4, and a head portion 5. The neck portion 3 connects the first showerhead assembly 1 and the second showerhead assembly 2 to the showerhead arm 10. In doing so, the neck portion 3 of the first showerhead assembly 1 is perpendicularly connected to the showerhead arm 10. The neck portion 3 of the second showerhead assembly 2 is perpendicularly and terminally connected to the showerhead arm 10 so that the first showerhead assembly 1 and the second showerhead assembly 2 are horizontally aligned to each other. The mount 4, for both the first showerhead assembly 1 and the second showerhead assembly 2, is terminally connected to the neck portion 3 opposite to the showerhead arm 10. The head portion 5, which releases water drawn from the water source, is connected to the mount 4 opposite to the neck portion 3. As seen in FIG. 2 and FIG. 3, the size and shape of the head portion 5 can vary according to user preference. For the water to flow from the first showerhead assembly 1 and the second showerhead assembly 2, the first showerhead assembly 1 and the second showerhead assembly 2 are in fluid communication with the showerhead arm 10.

Different users have varying preferences when showering. As an example, some users may prefer the water to be released from the showerhead assembly at a high pressure. On the other hand, some users may prefer the water to be released from the showerhead assembly at a lower pressure. As seen in FIGS. 2-4, to accommodate the varying needs, the present invention comprises a plurality of openings 11 that are equidistantly distributed along the head portion 5 opposite to the mount 4. The size and shape of the plurality of openings 11 can vary from one embodiment to another so that varying preferences can be fulfilled.

As mentioned earlier, the present invention allows the user to have individual control over the water flow of the first showerhead assembly 1 or the second showerhead assembly 2. As seen in FIGS. 1-5, the present invention further comprises a fluid flow control valve 6 that is integrated into the showerhead arm 10 in between the first showerhead assembly 1 and the second showerhead assembly 2. With the use of the fluid flow control valve 6, the water release from the second showerhead assembly 2 can be stopped and only the first showerhead assembly 1 can be used.

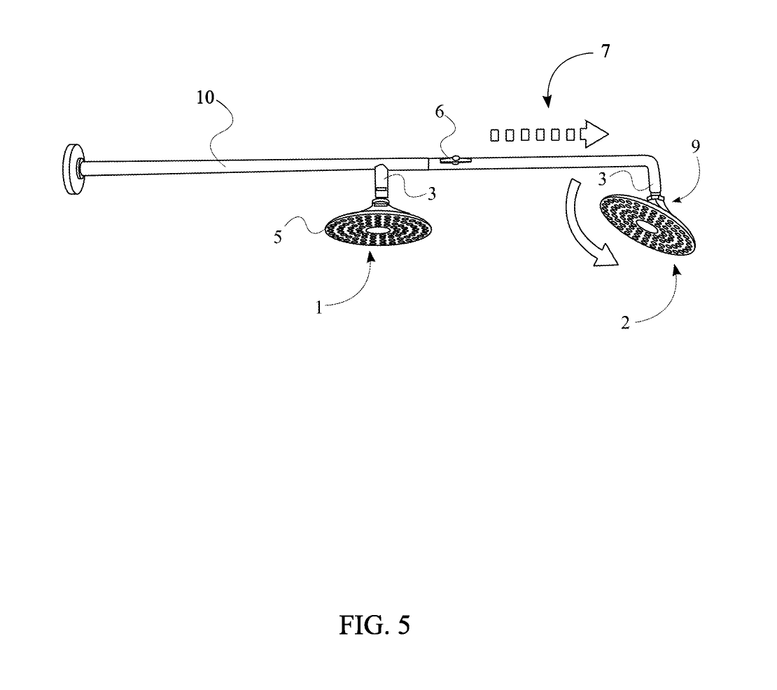

One of the main expectations of the present invention is to allow multiple users to shower together conveniently. To do so, as shown in FIG. 5, the present invention further comprises a length adjusting mechanism 7 which is integrated into the showerhead arm 10 in between the first showerhead assembly 1 and the second showerhead assembly 2. With the use of the length adjusting mechanism 7, a second user can extend the second showerhead assembly 2 away from first showerhead assembly 1. The length adjusting mechanism 7 also allows users with different abilities utilize the present invention. As an example, if an elderly person is using a shower seat and wishes to have the second showerhead assembly 2 away from the wall, the length adjusting mechanism 7 is extremely beneficial.

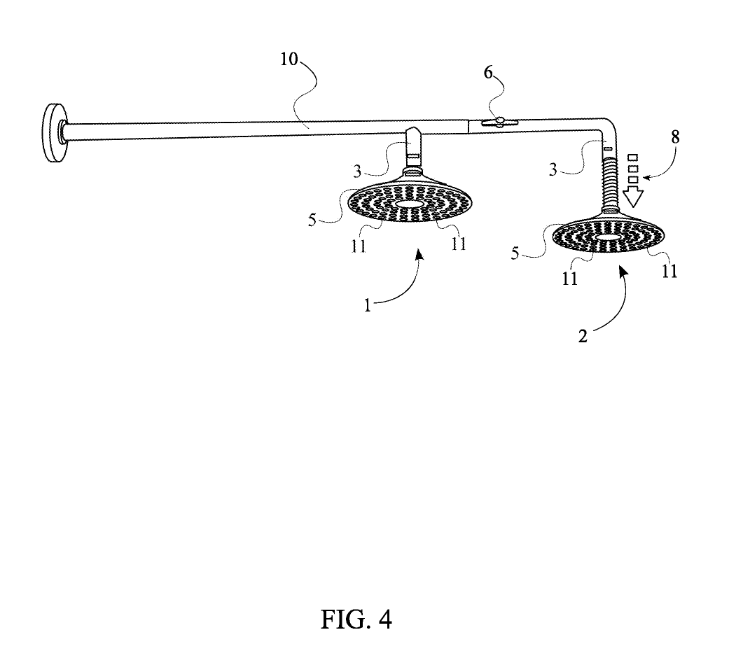

As illustrated in FIG. 4, to further increase the number of users, the present invention further comprises a height adjusting mechanism 8. Therefore, users of different heights can utilize the present invention. As an example, if a parent intends on bathing a child, or a pet owner intends on washing a pet, the height adjusting mechanism 8 is extremely beneficial. The height adjusting mechanism 8 is integrated into the neck portion 3 of both the first showerhead assembly 1 and the second showerhead assembly 2. Thus, the first showerhead assembly 1 can be controlled independent of the second showerhead assembly 2 or vice versa. The height adjusting mechanism 8 can vary in different embodiments of the present invention. In the preferred embodiment of the present invention, the height adjusting mechanism 8 is a collapsible/accordion hose that can be extended according to user preference.

The preferred direction of water flow when showering varies from one individual to another. As illustrated in FIG. 5, to accommodate the varying needs, the present invention further comprises an angle adjusting mechanism 9 which is integrated into the mount 4 of the first showerhead assembly 1 and the mount 4 of the second showerhead assembly 2. Since the head portion 5 is connected to the neck portion 3 via the mount 4, the user can orient the head portion 5 in a preferred direction with the use of the angle adjusting mechanism 9.

When the present invention is being used, the following process flow is generally followed. Initially, the present invention is connected to the water supply through the showerhead arm 10. The connection allows the water to flow into and out of the first showerhead assembly 1 and the second showerhead assembly 2. More specifically, water is released through the plurality of openings 11 distributed on the head portion 5. If the waterflow out of the second showerhead assembly 2 is not required, the user utilizes the fluid flow control valve 6 to stop water from flowing to the second showerhead assembly 2. When a first user and a second user are utilizing the present invention, and the second user intends to reposition the second showerhead assembly 2, the length adjusting mechanism 7 is used. However, in another embodiment of the present invention, a secondary length adjusting mechanism can be included to adjust the position of the first showerhead assembly 1. By using the length adjusting mechanism 7, the second showerhead assembly 2 is either distanced or moved closer to the first showerhead assembly 1. When the height of the head portion 5 needs to change, the user utilizes the height adjusting mechanism 8 which is integrated into the neck portion 3. As a result, users of different heights can conveniently utilize the present invention. When the direction of waterflow needs to change, the user utilizes the angle adjusting mechanism 9 integrated into the mount 4. Thus, the user has a unique showering experience.

Although the invention has been explained in relation to its preferred embodiment, it is to be understood that many other possible modifications and variations can be made without departing from the spirit and scope of the invention as hereinafter claimed.

What is claimed is:

1. Adjustable dual showerhead unit comprises:
a first showerhead assembly;
a second showerhead assembly;
a showerhead arm;
the first showerhead arm and the second showerhead assembly each comprise a neck portion, a mount, and a head portion;
the neck portion of the first showerhead assembly being perpendicularly connected to the showerhead arm;
the mount of the first showerhead assembly being terminally connected to the neck portion of the first showerhead assembly opposite the showerhead arm;
the neck portion of the second showerhead assembly being terminally and perpendicularly connected to the showerhead arm;
the mount of the second showerhead assembly being terminally connected to the neck portion of the second showerhead assembly opposite the showerhead arm;
the head portion being connected to the mount opposite to the neck portion; and
the first showerhead assembly and the second showerhead assembly being in fluid communication with the showerhead arm.

2. The adjustable dual showerhead unit as claimed in claim 1 further comprises:
a fluid flow control valve; and
the fluid flow control valve being integrated into the showerhead arm in between the first showerhead assembly and the second showerhead assembly.

3. The adjustable dual showerhead unit as claimed in claim 1 further comprises:
a length adjusting mechanism; and
the length adjusting mechanism being integrated into the showerhead arm in between the first showerhead assembly and the second showerhead assembly.

4. The adjustable dual showerhead unit as claimed in claim 1 further comprises:
a height adjusting mechanism; and
the height adjusting mechanism being integrated into the neck portion of the first showerhead assembly and the neck portion of the second showerhead assembly.

5. The adjustable dual showerhead unit as claimed in claim 4, wherein the height adjusting mechanism is a collapsible/accordion hose.

6. The adjustable dual showerhead unit as claimed in claim 1 further comprises:
an angle adjusting mechanism; and
the angle adjusting mechanism being integrated into the mount of the first showerhead assembly and the mount of the second showerhead assembly.

7. The adjustable dual showerhead unit as claimed in claim 1 further comprises:
a plurality of openings; and
the plurality of openings equidistantly distributed along the head portion opposite to the mount.

8. The adjustable dual showerhead unit as claimed in claim 1, wherein the first showerhead assembly and the second showerhead assembly are manufactured from plastic.

9. The adjustable dual showerhead unit as claimed in claim 1, wherein the first showerhead assembly and the second showerhead assembly are manufactured from aluminum.
